(19) United States
(12) Patent Application Publication
(10) Pub. No.: US 2022/0190753 A1
(43) Pub. Date: Jun. 16, 2022

(54) POWER TRANSFER OF MULTIPLE MOTORS

(71) Applicant: Hewlett-Packard Development Company, L.P., Spring, TX (US)

(72) Inventors: Yongho You, Pangyo (KR); Hyoungil Kim, Pangyo (KR); Jiyoung Byun, Pangyo (KR); Hakkyum Kim, Pangyo (KR); Sungdae Kim, Suwon (KR)

(73) Assignee: Hewlett-Packard Development Company, L.P., Spring, TX (US)

(21) Appl. No.: 17/311,750

(22) PCT Filed: Feb. 5, 2020
(86) PCT No.: PCT/US2020/016715

§ 371 Date: Jun. 8, 2021

(30) Foreign Application Priority Data
Sep. 2, 2019 (KR) 10-2019-0108041

(51) Int. Cl. H02P 5/485; B41J 29/38; F16H 59/40; F16H 59/14; F16H 63/50; F16H 1/22

(52) U.S. Cl. CPC H02P 5/485; B41J 29/38; F16H 59/40; H02P 2207/01; F16H 63/50; F16H 1/22; F16H 59/14

(57) ABSTRACT

An example power delivery device includes a drive shaft to connect with a load, a first motor connected with the drive shaft through a first reducer, and at least one second motor connected with the drive shaft through a second reducer, wherein a first final driven gear of the first reducer is directly connected with the drive shaft, and a second final driven gear of the second reducer is connected with the drive shaft through a one-direction connector.

### BACKGROUND OF THE INVENTION

Driving units operated by motors may be installed in an image forming apparatus such as a laser printer. The driving units may include a transfer unit for transferring an image onto a recording medium such as paper, and a fixing unit for fixing the image to the recording medium by applying heat and pressure to the toner image transferred to the recording medium.

The motor that drives these driving units may be a low-cost and standardized motor assembly that includes a printed circuit board (PCB) that can handle signals from the motor.

### BRIEF DESCRIPTION OF THE DRAWINGS

Various examples will be described below by referring to the following figures.

FIG. 1 is a side view illustrating a power delivery device according to an example.

FIG. 2 is a cross-sectional view illustrating a drive shaft, a first reducer, and a second reducer according to an example.

FIG. 3 is a block diagram illustrating a controller of a power delivery device according to an example.

FIG. 4 is a flowchart illustrating a control method of a power delivery device according to an example.

FIG. 5 is a block diagram illustrating a controller of a power delivery device according to an example.

FIG. 6 is a flowchart illustrating a control method of a power delivery device according to an example.

FIG. 7 and FIG. 8 are graphs showing a speed variation of a motor according to an example.

FIG. 9 and FIG. 10 are graphs showing a torque change of a motor according to an example.

### DETAILED DESCRIPTION OF EXAMPLES

As those skilled in the art will realize, the following described examples may be modified in various different ways, all without departing from the spirit or scope of the present invention.

In order to clarify the present invention, parts that are not relevant to the description will be omitted, and the same elements or equivalents are referred to by the same reference numerals throughout the specification.

Each of the size and thickness of each element is arbitrarily shown in the drawings and the present invention is not necessarily limited thereto. In the drawings, the thickness of layers, films, panels, regions, etc., may be exaggerated for clarity.

In recent years, the magnitude of a load driven by one motor has gradually increased in an image forming apparatus. For example, driving units operated by a motor, such as a transfer unit for transferring an image onto a recording medium, a fixing unit for fixing the image to the recording medium, or the like, may be installed in the image forming apparatus.

To this end, when a drive shaft connected with the load is operated by a plurality of motors, since the motor speeds may not coincide with each other, the operation of one motor may act as a load on another motor. Thus, a speed variation of the drive shaft may be increased as compared to when the drive shaft is operated by one motor. In addition, when an excessive load is applied to one of a plurality of motors, the motor may be operated out of its normal torque range, which may cause the motor to stall.

When the load of a driving unit to be operated by one motor exceeds the capacity of the motor, usage of a larger capacity motor may be considered. However, if a larger capacity motor is used, the price of the product may increase.

In addition, the load of each driving unit operated by the motor may be increased or decreased. For example, the load of each driving unit operated by the motor may be instantaneously increased or decreased due to an impact occurring when the printing medium (e.g., paper) enters or exits a printing mechanism. In this case, speed fluctuations may occur in the drive unit, which may deteriorate the quality of an image printed on the printing medium and increase jitter.

According to an example, the combined torque of a plurality of motors allows the operating of large loads connected with one drive shaft, and a speed variation of the drive shaft according to a variation of the load connected to the drive shaft may be minimized.

Hereinafter, a power delivery device according to an example will be described with reference to the accompanying drawings.

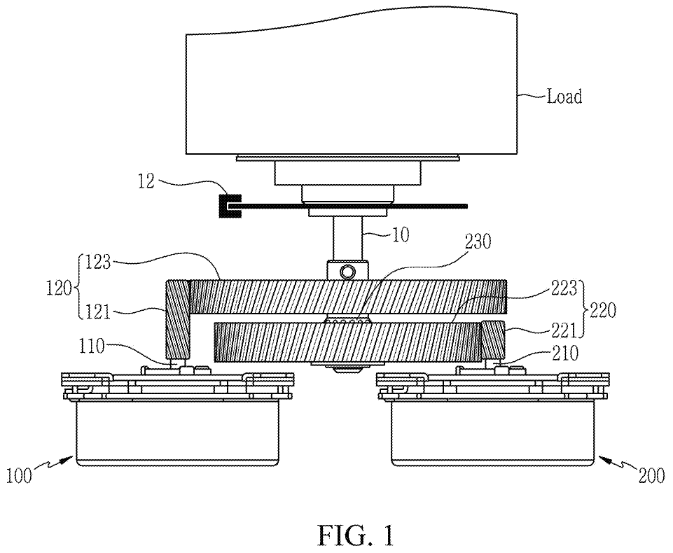

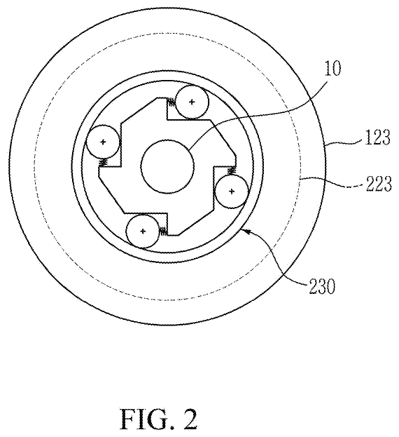

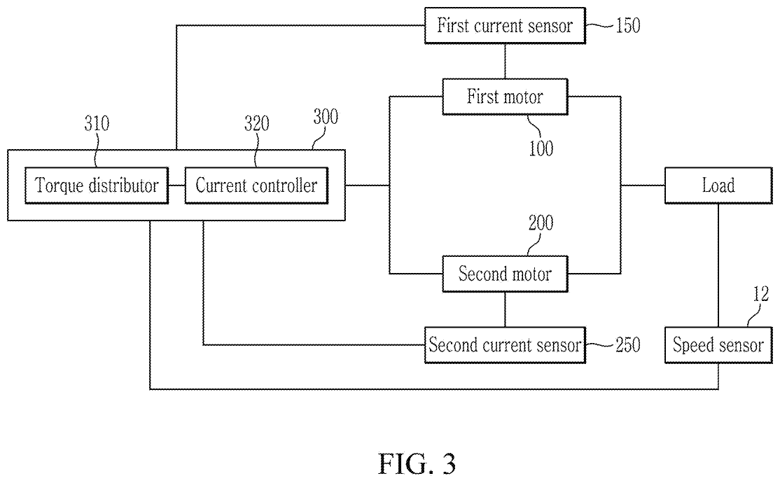

FIG. 1 is a side view illustrating a configuration of a power delivery device according to an example. FIG. 2 is a cross-sectional view illustrating a configuration of a drive shaft, a first reducer, and a second reducer according to an example. FIG. 3 is a block diagram illustrating a controller of a power delivery device according to an example.

Referring to FIGS. 1 and 2, a power transmission apparatus may include a drive shaft 10 to connect to a load, and at least two motors to generate rotational power of the drive shaft 10.

The drive shaft 10 may be connected to a load such as an Organic Photo Conductor (OPC) drum, an intermediate transfer belt, a fusing belt, or the like disposed inside an image forming apparatus such as a laser printer.

The at least two motors may include a first motor 100 and a second motor 200. In an example, the first motor 100 and the second motor 200 may be asynchronous motors. In the case of using a synchronous motor such as a step motor, the motor may misstep due to a fine speed mismatch. However, by using an asynchronous motor for the first motor 100 and an asynchronous motor for the second motor 200, the drive shaft 10 can be more stably operated.

In an example, the load may be connected with the drive shaft 10 and controlled by the first motor 100. However, the second motor 200 may assist the first motor 100 when the magnitude of the load connected with the drive shaft 10 is changed (for example, when the magnitude of the load is changed due to an external vibration or impact, when a plurality of drive units are connected to the drive shaft 10, or the like). Thus, the first motor 100 may act as a main motor and the second motor 200 may act as an auxiliary motor to provide additional torque when the magnitude of the load connected to the drive shaft 10 is changed.

The first motor 100 may be connected with the drive shaft 10 through a first reducer 120. In an example, a final driven gear of the first reducer 120 may be directly connected (or fixedly connected) to the drive shaft 10. For example, the final driven gear of the first reducer 120 may be fixedly connected to the drive shaft 10 through a process such as press fitting.

The first reducer 120 may include one or more gear trains having a plurality of gears. For example, the first reducer 120 may include a first drive gear 121 fixedly connected with a rotation shaft 110 of the first motor 100 and a first driven gear 123 fixedly connected with the drive shaft 10.

The second motor 200 may be connected with the drive shaft 10 through a second reducer 220. In an example, a final driven gear of the second reducer 220 may be connected with the drive shaft 10 through a one-directional connector 230. As an example, the one-directional connector 230 may be implemented as a one-way bearing.

The second reducer 220 may include one or more gear trains having a plurality of gears. For example, the second reducer 220 may include a second drive gear 221 fixedly connected with a rotation shaft 210 of the second motor 200, and a second driven gear 223 connected with the drive shaft 10 through the one-way bearing. In an example, the second driven gear 223 may be fixedly connected with an outer ring of the one-way bearing, and the drive shaft 10 may be fixedly connected with an inner ring of the one-way bearing (see FIG. 2).

In an example, one second motor 200 is connected with the drive shaft 10. However, the scope of the present disclosure is not limited thereto, and a plurality of second motors 200 may be connected to the drive shaft 10.

In an example, a reduction ratio of the first reducer 120 may be greater than a reduction ratio of the second reducer 220. For example, the reduction ratio of the first reducer 120 may be set to 20:1, and the reduction ratio of the second reducer 220 may be set to 8:1.

Since the first motor 100 acts as the main motor, the reduction ratio of the first reducer 120 may be set to cope with a low speed and a high load. The reduction ratio of the second reducer 220 may be set so as to support the torque of the first motor 100 when the load connected to the drive shaft 10 is fluctuated, thereby improving responsiveness of the second motor 200. In an example, by setting the reduction ratio of the first reducer 120 to be greater than the reduction ratio of the second reducer 220, a speed ripple of the drive shaft 10 is reduced even if the magnitude of the load connected to the drive shaft 10 changes instantaneously.

In an example, the load of the driving unit may not be temporarily increased. Rather, it may occur that the driving unit having large capacity is continuously operated using the combined torque of the first motor 100 and the second motor 200. In this case, the reduction ratio of the first reducer 120 does not necessarily need to be greater than the reduction ratio of the second reducer 220, and the reduction ratio of the first reducer 120 may be set equal to or smaller than the reduction ratio of the second reducer 220.

As described above, the final driven gear of the second motor 200 is connected with the drive shaft 10 through the one-way bearing. Therefore, the power of the second motor 200 is transmitted to the drive shaft 10 only when the second motor 200 rotates in one direction (e.g., clockwise). And when the second motor 200 rotates in the other direction (e.g., counter-clockwise), the final driven gear of the second motor 200 is in a free rotation state and the power of the second motor 200 is not transmitted to the drive shaft 10.

For example, since the final driven gear 123 of the first motor 100 is fixedly connected to the drive shaft 10 and the final driven gear 223 of the second motor 200 is connected to the drive shaft 10 through the one-directional connector 230, the power of the second motor 200 is transmitted to the drive shaft only when the rotational speed of the final driven gear 223 of the second reducer 220 is greater than or equal to the rotational speed of the final driven gear 123 of the first reducer 120. That is, when the rotation speed of the final driven gear 223 of the second reducer 220 is slower than the rotation speed of the final driven gear 123 of the first reducer 120, the power generated in the second motor 200 is not transmitted to the drive shaft 10.

Therefore, the second motor 200 assists the torque of the first motor 100 according to the speed of the first motor 100 and the second motor 200, and the combined torque of the first motor 100 and the second motor 200 is transmitted to the drive shaft 10.

Referring to FIG. 3, an example power delivery device may further include a drive shaft speed sensor 12 for detecting a rotational speed of the drive shaft 10, and a motor controller 300 to control an operation of the first motor 100 and the second motor 200 based on the rotational speed of the drive shaft 10 detected by the drive shaft speed sensor 12. The motor controller 300 may be a controller that integrally controls the operations of the first motor 100 and the second motor 200 or may be implemented as two controllers to control the operations of the first motor 100 and the second motor 200, respectively.

To this end, the motor controller 300 may be realized as at least one microprocessor programed with a predetermined program, and the predetermined program may include a set of instructions for performing a method according to the examples described herein.

In an example, the drive shaft speed sensor 12 that detects the rotation speed of the drive shaft 10 may be an encoder provided in the drive shaft 10, and the rotational speed of the drive shaft 10 detected by the encoder may be transmitted to the motor controller 300.

The motor controller 300 may perform speed control by adjusting a current applied to the first motor 100 and a current applied to the second motor 200 so that the rotation speed of the drive shaft 10 detected by the drive shaft speed sensor 12 follows a target speed.

The motor controller 300 may include a torque distributor 310 that distributes a torque amount output through the first motor 100 and the second motor 200 based on the magnitude of the load connected to the drive shaft 10. The motor controller 300 may also include a first current sensor 150 for detecting current applied to the first motor 100, a second current sensor 250 for detecting current applied to the second motor 200, and a current controller 320 for adjusting a current output to the first motor 100 and a current output to the second motor 200 based on the torque amount distributed by the torque distributor 310 and current applied to the first motor 100 and the second motor 200 detected by the first and second current sensors 150 and 250. In an example, the current controller 320 may be configured as a proportional-integral-derivative (PID) controller.

In an example, the motor controller 300 controls the first motor 100 and the second motor 200 through pulse width modulation (PWM) control, and the motor controller 300 may indirectly measure the current supplied to each motor from a duty ratio (or pulse width) of the PWM signal applied to each motor.

That is, the current controller 320 may estimate the torque output from the first motor 100 and the torque output from the second motor 200 in response to the current values applied to the first motor 100 and the second motor 200. The current controller 320 may adjust current supplied to the first motor 100 and current supplied to the second motor 200 such that the first motor 100 and the second motor 200 output torque distributed by the toque distributor 310.

The torque distributor 310 may adjust a torque amount output from the first motor 100 and a torque amount output from the second motor 200 in consideration of the response characteristics of the first motor 100 and the second motor 200. The response characteristics of the first motor 100 and the second motor 200 may be determined by the reduction ratio of the first reducer 120 and the second reducer 220, and the torque may be distributed so that a motor with a faster response characteristic outputs more torque.

Hereinafter, an operation of the power delivery device according to an example as described above will be described with reference to the accompanying drawings.

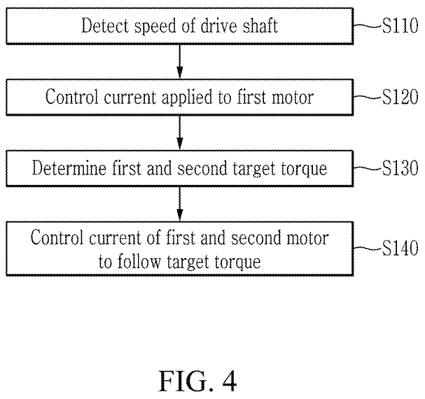

FIG. 4 is a flowchart illustrating a control method of a power delivery device according to an example.

Referring to FIG. 4, the rotational speed of the drive shaft 10 is detected by the drive shaft speed sensor 12 and transmitted to the motor controller 300 at operation S110.

The current controller 320 of the motor controller 300 generates a current command to be applied to the first motor 100 so that the rotational speed of the drive shaft 10 follows the target speed at operation S120. That is, in the general case, since the drive shaft 10 connected with the load is to be rotated at a constant speed, the drive shaft 10 is operated by the speed control of the first motor 100.

When the magnitude of the load connected with the drive shaft 10 is changed, the torque distributor 310 of the motor controller 300 determines a first target torque that the first motor 100 should output and a second target torque that the second motor 200 should output according to the magnitude of the load connected with the drive shaft 10 at operation S130.

The current controller 320 of the motor controller 300 generates a current command for the first motor 100 and a current command for the second motor 200 to output respective target torques at operation S140. In this case, the current controller 320 of the motor controller 300 may control the first motor 100 and the second motor 200 to output respective target torques by continuously receiving the current supplied to the first motor 100 and the second motor 200.

A power delivery device according to an example may perform speed control of the first motor 100 to follow the rotational speed of the drive shaft 10, but the speed variation may be minimized by torque control that assists the torque of the first motor 100 through the second motor 200 when the load connected with the drive shaft 10 is changed.

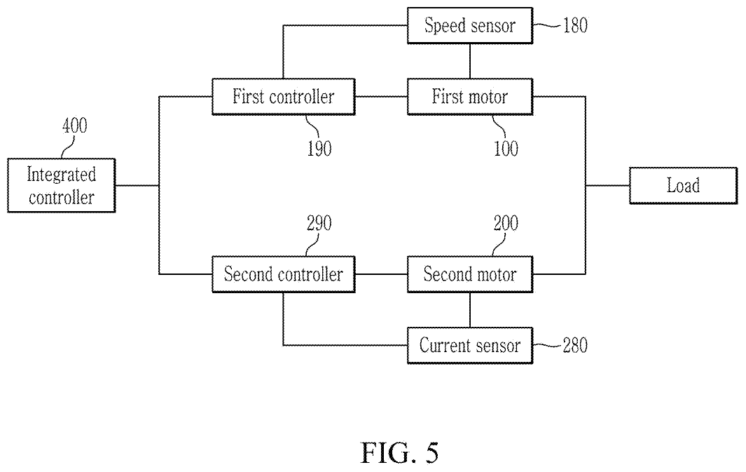

FIG. 5 is a block diagram illustrating a controller of a power delivery device according to an example.

Referring to FIG. 5, the power delivery device may include a first controller 190 for controlling the speed of the first motor 100 and a second controller 290 for controlling the torque of the second motor 200. In this case, the power delivery device may further include an integrated controller 400 for integrally controlling the operation of the first controller 190 and the second controller 290.

In the example of FIG. 5, the operations of the first motor 100 and the second motor 200 are controlled by the first controller 190, the second controller 290, and the integrated controller 400. However, the first controller 190, the second controller 290, and the integrated controller 400 may be configured as one controller. That is, while the first motor 100 and the second motor 200 are operated by speed control according to the example of FIG. 3, the first motor 100 is operated by speed control and the second motor 200 is operated by torque control according to the example of FIG. 5.

The first controller 190 may adjust the current applied to the first motor 100 so that the output speed of the first motor 100 follows the target speed.

To this end, the power delivery device may include a rotation shaft speed sensor 180 for detecting the speed of the rotation shaft 110 of the first motor 100. The rotation shaft speed sensor 180 may be a frequency generator (FG) to output the speed of the rotation shaft 110 of the first motor 100, or may be a Hall sensor to sense the speed of the rotation shaft 110 of the first motor 100. The speed of the rotation shaft 110 output from the rotation shaft speed sensor 180 is transmitted to the first controller 190.

In general, a standardized motor includes a motor assembly with a printed circuit board (PCB) that processes a signal output from the motor together with a motor unit. The PCB may be provided with a Hall sensor for detecting the speed of the rotation shaft of the motor. Alternatively, a frequency generator (FG) for outputting the speed of the rotation shaft of the motor may be provided. Such Hall sensor or frequency generator is relatively inexpensive compared to an encoder that detects the rotational speed of the drive shaft.

The second controller 290 controls the torque (or current) of the second motor 200 without controlling the speed of the second motor 200. To this end, the power delivery device may include a current sensor 280 for detecting the current applied to the second motor 200. The amount of current applied to the second motor 200 is detected by the current sensor 280 and transmitted to the second controller 290.

Alternatively, the second controller 290 may control the second motor 200 through PWM control, and the second controller 290 may indirectly measure the current supplied to the second motor 200 from a duty ratio (or pulse width) of a PWM signal applied to the second motor 200.

The integrated controller 400 may determine the torque amount to be output from the second motor 200 based on the load connected with the drive shaft 10. When the torque amount to be output from the second motor 200 is determined by the integrated controller 400, the second controller 290 controls the torque of the second motor 200. The second controller 290 adjusts the amount of current applied to the second motor 200 so that the second motor 200 outputs the torque determined by the integrated controller 400.

When the speed of the second gear train (e.g., speed transmitted from the second motor 200 to the drive shaft 10 through the second reducer 220) is lower than the speed of the first gear train (e.g., speed transmitted from the first motor 100 to the drive shaft 10 through the first reducer 120), the load connected with the drive shaft 10 is not applied to the second motor 200 and the torque amount output from the second motor 200 becomes smaller than the target torque determined by the integrated controller 400. Therefore, when the second controller 290 increases the amount of current applied to the second motor 200 to increase the amount of torque output from the second motor 200, the speed of the second motor 200 is increased and the speed of the second gear train (e.g., speed transmitted from the second motor 200 to the drive shaft 10 through the second reducer 220) becomes faster than the speed of the first gear train (e.g., speed transmitted from the first motor 100 to the drive shaft 10 through the first reducer 120). Therefore, the torque output from the second motor 200 is transmitted to the drive shaft 10.

On the contrary, when the speed of the second gear train (e.g., speed transmitted from the second motor 200 to the drive shaft 10 through the second reducer 220) is faster than the speed of the first gear train (e.g., speed transmitted from the first motor 100 to the drive shaft 10 through the first reducer 120), the power (or torque) generated from the second motor 200 is transmitted to the drive shaft 10. At this time, when the torque transmitted from the second motor 200 to the drive shaft 10 becomes greater than the target torque determined by the integrated controller 400, the second controller 290 controls the current supplied to the second motor 200 to be decreased, thereby causing the speed of the second gear train to be decreased.

Hereinafter, an example operation of a power delivery device will be described with reference to the accompanying drawings.

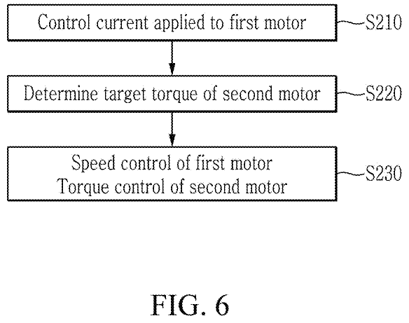

FIG. 6 is a flowchart illustrating a control method of a power delivery device according to an example.

Referring to FIG. 6, the first controller 190 may control the current applied to the first motor 100 so that the rotational speed of the first motor 100 follows the target speed at operation S210. That is, in the general case, since the drive shaft 10 connected with the load should be rotated at a constant speed, the drive shaft 10 is operated by the speed control of the first motor 100.

When the load connected with the drive shaft 10 is changed, the integrated controller 400 determines the torque that the second motor 200 should output for the entire load connected with the drive shaft 10 at operation S220.

The first controller 190 may control the operation of the first motor through the speed control and the second controller 290 may control the operation of the second motor 200 through the torque control at operation S230. As an example, the first controller 190 adjusts the current supplied to the first motor 100 based on the speed of the first motor 100 detected by the rotation shaft speed sensor 180 so that the first motor 100 follows the target speed. And the second controller adjusts the current supplied to the second motor 200 based on the current of the second motor detected by the current sensor 280 so that the second motor outputs the target torque.

In an example, the power delivery device controls the speed of the drive shaft 10 through the speed control of the first motor 100. But when the magnitude of the load connected with the drive shaft 10 is changed, the second controller 290 controls the second motor 200 through the torque control to assist the torque of the first motor 100, thereby minimizing a speed variation of the drive shaft 10.

In the example described above, the power delivery device does not include a sensor for measuring the speed of the drive shaft 10. Speed sensors, such as an encoder that measure the speed of drive shaft 10, are relatively expensive, which is an additional factor in manufacturing costs. However, a Hall sensor or a frequency generator (FG) provided in a standardized motor assembly is less expensive. Thus, the described example is not provided with an additional sensor (e.g., an encoder) for measuring the speed of the drive shaft 10, but the drive shaft 10 is controlled by speed control through the speed sensor (e.g., Hall sensor or FG) provided in a standardized motor. Therefore, the manufacturing cost may be reduced.

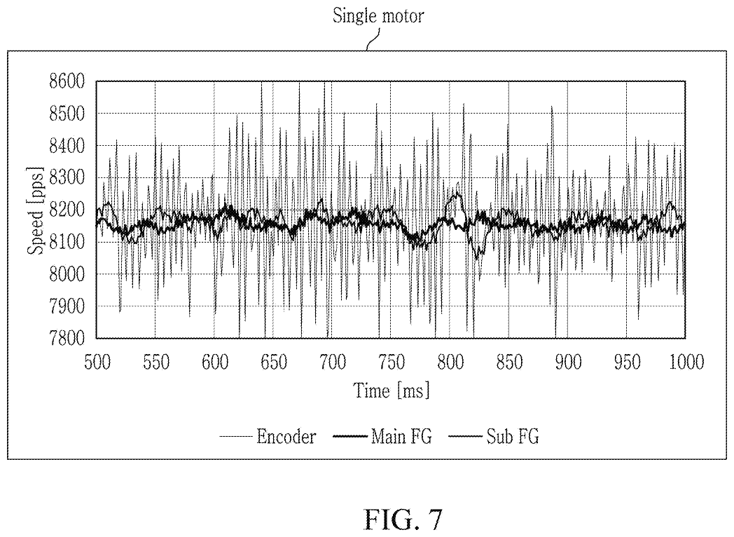

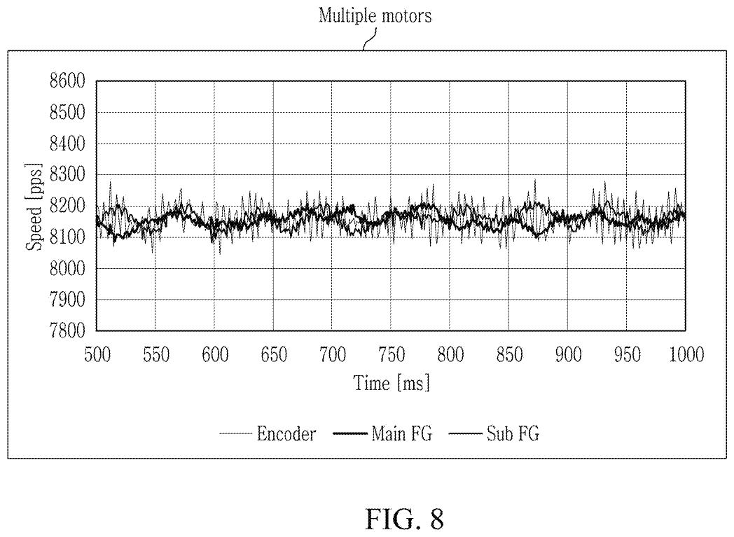

FIG. 7 and FIG. 8 are graphs showing a speed variation of a motor according to an example. In more detail, FIG. 7 is a graph showing a speed ripple of a motor when a drive shaft is controlled by a single motor, and FIG. 8 is a graph showing a speed ripple of each motor according to an example.

Referring to FIG. 7 and FIG. 8, when two motors are connected to one drive shaft 10 through a one-directional connector such as a one-way bearing, it can be seen that the speed variation of the motor is reduced as compared to the case where the drive shaft 10 is driven by a single motor.

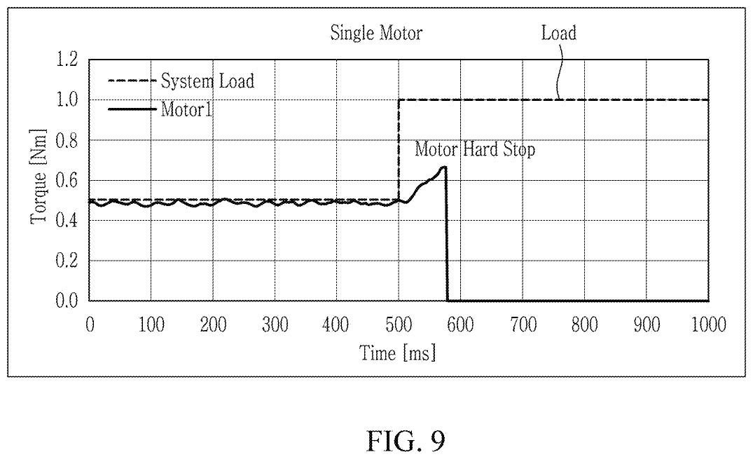

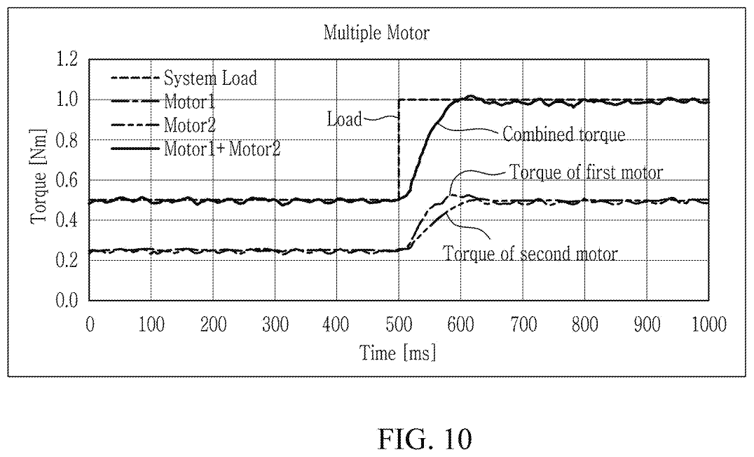

FIG. 9 and FIG. 10 are graphs showing a torque change of a motor according to an example. In more detail, FIG. 9 is a graph showing a torque variation of a motor when a single motor is connected to a drive shaft, and FIG. 10 is a graph showing a torque variation of each motor in a power delivery device according to an example.

Referring to FIG. 9, when only one motor is connected to the drive shaft 10, it can be seen that if the magnitude of the load temporarily exceeds the capacity of the motor, the motor does not operate normally and the motor stops abnormally.

Referring to FIG. 10, even though the load connected with the drive shaft 10 rapidly increases, since the auxiliary motor (second motor 200) assists the torque of the main motor (first motor 100), it can be seen that the two motors properly respond to the load variation.

According to an example power delivery device, by connecting a lower-cost main motor and an auxiliary motor to one drive shaft 10, even if the load connected to the drive shaft 10 is changed, the auxiliary motor (second motor 200) may assist the power of the main motor (first motor 100).

In addition, since the reduction ratio of the auxiliary reducer (e.g., second reducer) connected with the auxiliary motor (e.g., second motor) is smaller than the reduction ratio of the main reducer (e.g., first reducer) connected with the main motor (e.g., first motor), the response characteristic through the auxiliary motor (e.g., second motor) is faster than the response characteristic of the main motor (e.g., first motor). Therefore, it is possible to minimize a speed variation of each motor and the drive shaft even though the load connected with the drive shaft 10 is changed. Thus, image bands and jitter can be reduced to improve image quality.

According to an example power delivery device, a plurality of motors including the main motor (e.g., first motor) and the auxiliary motor (e.g., second motor) are connected to one drive shaft, and the auxiliary motor (e.g., second motor) assists the power of the main motor (e.g., first motor) according to a speed difference between the main motor (e.g., first motor) and the auxiliary motor (e.g., second motor). Therefore, even though the load connected with the drive shaft 10 is changed, it is possible to minimize a speed variation of the drive shaft.

Although examples have been described above, the present invention is not limited thereto, and the present invention may be modified in various ways within the scope of the claims and the detailed description and accompanying drawings of the invention, which falls within the scope of the present invention.

While this invention has been described in connection with what is presently considered to be practical examples, it is to be understood that the invention is not limited to the disclosed examples. On the contrary, it is intended to cover various modifications and equivalent arrangements included within the spirit and scope of the appended claims.

What is claimed is:

1. A power delivery device comprising:
a drive shaft to connect with a load;
a first motor connected with the drive shaft through a first reducer; and
at least one second motor connected with the drive shaft through a second reducer,
wherein a first final driven gear of the first reducer is directly connected with the drive shaft, and
wherein a second final driven gear of the second reducer is connected to the drive shaft through a one-direction connector.

2. The power delivery device of claim 1, further comprising:
a drive shaft speed sensor to detect a rotational speed of the drive shaft; and
a motor controller to control an operation of the first motor and the second motor based on the rotational speed of the drive shaft detected by the drive shaft speed sensor.

3. The power delivery device of claim 2, wherein the drive shaft speed sensor includes an encoder provided on the drive shaft.

4. The power delivery device of claim 2, wherein the motor controller is to:
compare a target speed with the rotational speed of the drive shaft detected by the drive shaft speed sensor; and
control a current applied to the first motor and a current applied to the second motor so that the rotational speed of the drive shaft follows the target speed.

5. The power delivery device of claim 4, wherein the motor controller comprises:
a torque distributor to distribute a torque amount output through the first motor and the second motor according to a magnitude of the load connected to the drive shaft; and
a current controller to generate a target current command output to the first motor and the second motor according to the torque distributed from the torque distributor.

6. The power delivery device of claim 5, wherein the current controller is to generate the target current command in response to the current applied to the first motor and the current applied to the second motor.

7. The power delivery device of claim 1, further comprising:
a first controller to control a current applied to the first motor such that a speed of the first motor follows a target speed; and
a second controller to control a current applied to the second motor such that the second motor outputs a constant torque.

8. The power delivery device of claim 7, further comprising an integrated controller to determine a torque amount output from the second motor among a total load connected with the drive shaft.

9. The power delivery device of claim 7, wherein the first controller is to control the current applied to the first motor in response to a rotation speed of a rotation shaft of the first motor.

10. The power delivery device of claim 7, wherein the second controller is to control the current applied to the second motor in response to the current applied to the second motor.

11. The power delivery device of claim 10, wherein the second controller is to receive the current applied to the second motor from a current sensor provided in the second motor.

12. The power delivery device of claim 1, wherein a first gear ratio of the first reducer is greater than a second gear ratio of the second reducer.

13. The power delivery device of claim 1, wherein the first motor and the second motor are asynchronous motors.

14. The power delivery device of claim 1, wherein the one-direction connector comprises a one-way bearing.

15. The power delivery device of claim 14,
wherein a second final driven gear is connected with an outer ring of the one-way bearing, and
wherein the drive shaft is connected with an inner ring of the one-way bearing.
